(19) United States
(12) Patent Application Publication
(10) Pub. No.: US 2023/0134342 A1
(43) Pub. Date: May 4, 2023

(54) SYSTEM AND/OR METHOD FOR VEHICLE TRIP CLASSIFICATION

(71) Applicant: Zendrive, Inc., San Francisco, CA (US)

(72) Inventors: Sakshi Chandra, San Francisco, CA (US); Sambuddha Bhattacharya, San Francisco, CA (US); Jayanta Kumar Pal, San Francisco, CA (US)

(21) Appl. No.: 17/959,067

(22) Filed: Oct. 3, 2022

Related U.S. Application Data
(60) Provisional application No. 63/274,845, filed on Nov. 2, 2021.

(51) Int. Cl. G06Q 40/08; G06N 5/04

(52) U.S. Cl. CPC G06Q 40/08; G06N 5/04

(57) ABSTRACT

The system can include a plurality of data processing modules, which can include: a feature generation module, a scoring module, an optional decision module, an optional trip detection module, and/or any other suitable data processing modules. The system can optionally include a mobile device (e.g., such as a mobile cellular telephone, user device, etc.) and/or can be used in conjunction with a mobile device (e.g., receive data from an application executing at the mobile device and/or utilize mobile device processing, etc.). The system can function to classify a vehicular transportation modality (e.g., motorcycle transportation) for a vehicle trip.

### CROSS REFERENCE TO RELATED APPLICATIONS

This application claims the benefit of U.S. Provisional Application No. 63/274,845, filed 02-NOV-2021, which is incorporated herein in its entirety by this reference.

### TECHNICAL FIELD

This invention relates generally to the vehicular activity monitoring field, and more specifically to a new and useful system and/or method for monitoring vehicle-related user activity and vehicle motion in the vehicular activity monitoring field.

### BRIEF DESCRIPTION OF THE FIGURES

FIG. 1 is a schematic representation of a variant of the system.

FIG. 2 is a flow chart diagram of a variant of the method.

FIG. 3 is a flow chart diagram of a variant of trip detection.

FIG. 4 is a diagrammatic representation of a variant of trip classification.

FIG. 5 is a schematic representation of an example system.

FIG. 6 is a diagrammatic representation of a variant of trip classification.

FIG. 7 is a diagrammatic representation of a variant of trip classification.

FIG. 8 is a schematic representation of a variant of the system.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1 Overview

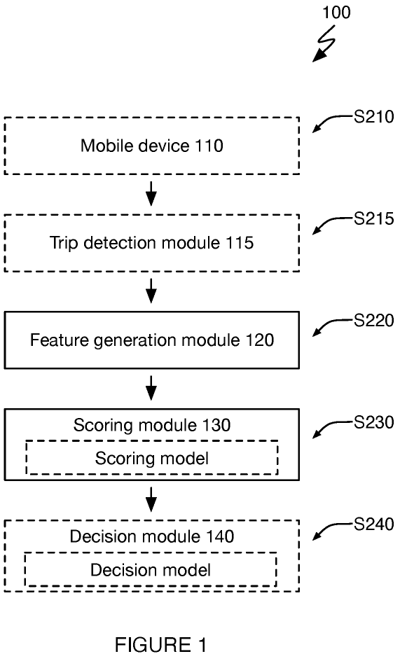

The system 100, an example of which is shown in FIG. 1, can include a plurality of data processing modules, which can include: a feature generation module 120, a scoring module 130, an optional decision module 140, an optional trip detection module 115, and/or any other suitable data processing modules. The system can optionally include a mobile device 110 (e.g., such as a mobile cellular telephone, user device, etc.) and/or can be used in conjunction with a mobile device 110 (e.g., receive data from an application executing at the mobile device and/or utilize mobile device processing, etc.). However, the system 100 can additionally or alternatively include any other suitable set of components. The system functions to facilitate execution of method Block S200 and/or can function to classify a vehicular transportation modality (e.g., motorcycle transportation) for a vehicle trip.

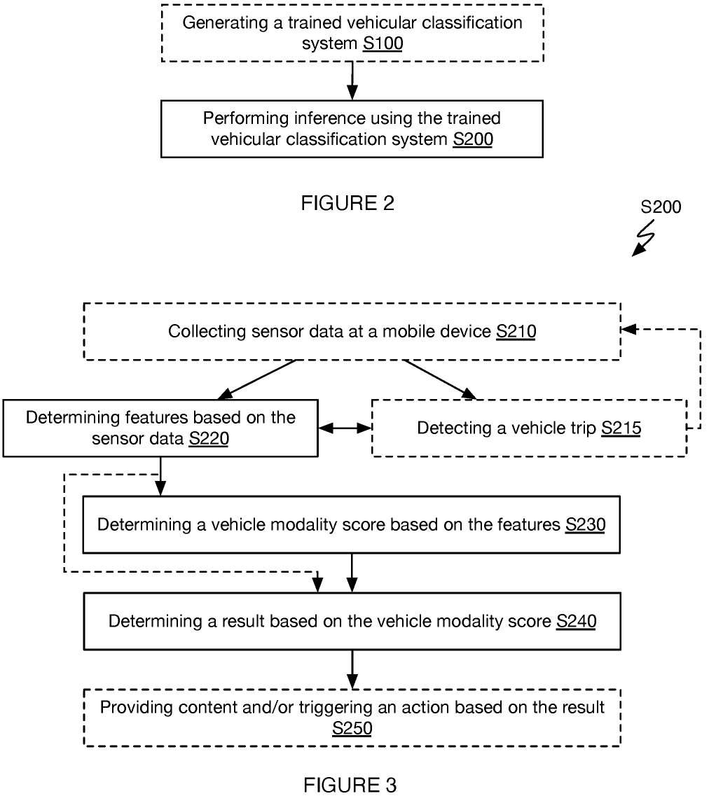

The method, an example of which is shown in FIG. 2, can include: optionally generating a trained vehicular classification system S100; and performing inference using the trained vehicular classification system S200. The method functions to facilitate determination of vehicle motion characteristics and/or to classify a vehicular transportation modality (e.g., motorcycle transportation) for a vehicle trip. However, the method can additionally or alternatively include any other suitable elements.

In a specific example, the S200 can be used to selectively classify trips as motorcycle trips.

Block S200, an example of which is shown in FIG. 3, can include: optionally collecting sensor data at a mobile device S210; determining features based on the sensor data S220; determining a vehicle modality score based on the features S230; determining a result based on the vehicle modality score S240; and optionally providing content or triggering another action based on the result S250. S200 functions to classify a vehicular transportation modality (e.g., a motorcycle trip) for a vehicle trip. S200 can additionally or alternatively function to determine vehicle motion characteristics for a trip. However, method Block S200 can additionally or alternatively include any other suitable elements.

In variants, the system and/or method can be used to detect a vehicle trip at a mobile device and, during the trip, determine if the vehicle is a motorcycle without any direct inputs from a user or communication with the vehicle. Additionally, the system and/or method may facilitate classification of a vehicle with the mobile device arranged arbitrarily (e.g., without a known/fixed position, movably) relative to the vehicle (e.g., in a user’s pocket, backpack, mounted to a dash/handlebar, etc.).

In variants, the system and/or method can be used to classify trips for any suitable set(s) of vehicles and/or transportation modalities which can include: motorway vehicle trips (e.g., car, motorcycle, commercial vehicle, vehicles with 3 or more axles, trucks, buses, etc.), land-based vehicle trips (e.g., human powered vehicles, scooters, cars, busses, trains, etc.), motor-vehicle trips, animal-powered trips, marine vessel trips, aircraft trips, and/or any other suitable vehicle trips and/or transport modalities. In a specific example, the system and/or method can be used to distinguish motorcycle trips from a remainder of driving trips (e.g., car trips) and/or roadway trips. However, the system and/or method can be used to classify any other suitable set of vehicular transport modalities.

### 1.1 Illustrative Examples.

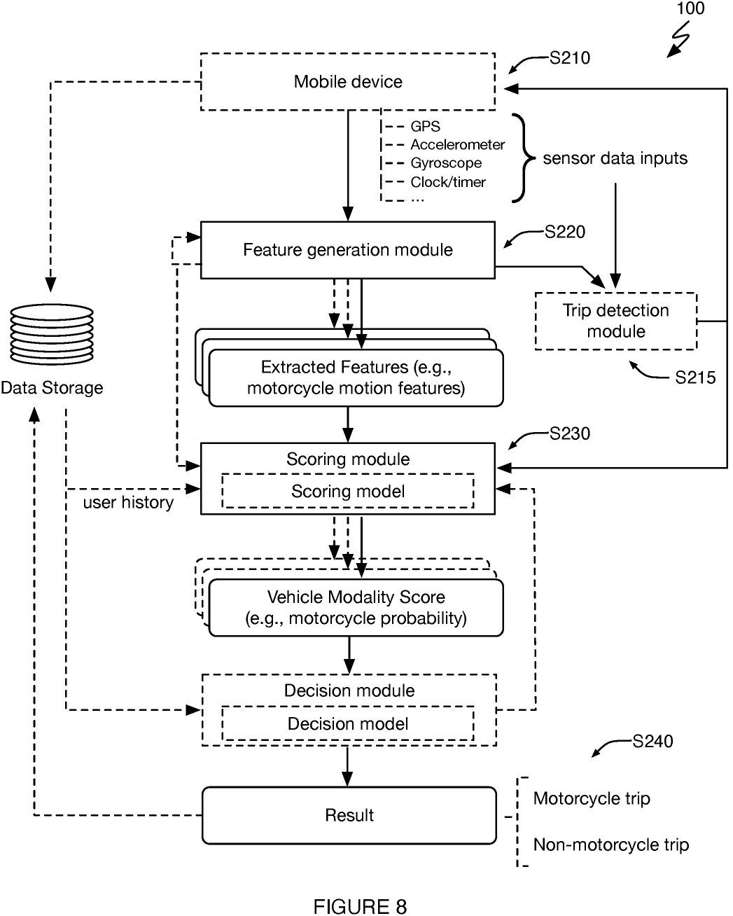

In a first set of variants (e.g., an example is shown in FIG. 8), the method S200 can include: at a mobile user device, automatically detecting a vehicle trip associated with vehicular transportation of the mobile user device using at least one of: a motion sensor of the mobile user device or a location sensor of the mobile user device; collecting a first dataset comprising movement data associated with at least of: the motion sensor or the location sensor of the mobile user device; extracting features from the first dataset, at the mobile user device, determining a motorcycle score based on the extracted features using a predetermined scoring model; based on the motorcycle score exceeding a confidence threshold, classifying the vehicle trip as a motorcycle trip; and triggering an action based on the vehicle trip classification. The features can include a movement feature which can be associated with at least one of:: a vehicle roll characteristic, a vehicle acceleration characteristic, a vehicle vibration characteristic, a high-order-derivative of a pose parameter (e.g., jerk; angular acceleration; etc.). For example, the action can include updating a usage parameter of a usage-based motorcycle insurance policy associated with a user of the mobile user device, based on the movement dataset (e.g., a distance and/or time associated with the trip).

In a first variant, features can be extracted for various segments of data (e.g., temporal windows, such as 30 second windows) within the first data segment, and separately scored for each segment.

In a second variant, features can be extracted for time periods surrounding vehicle events (e.g., detected based on sensor data and/or event classifications). For example, features can be extracted and separately scored for individual lane change events, cornering events, braking events, acceleration events, and/or any other suitable events.

In a third variant, separate features (e.g., determined for separate motion characteristics and/or using separate sensors) can be extracted across a full duration of the trip to determine a unified score for the full duration of the trip (e.g., from a start of initial movement to trip completion and/or from a start of initial movement to a present time). The unified score can be determined by: extracting a set of hierarchical features from the separate features, each embedding data from a plurality of separate features (e.g., relating distinct separate features of the plurality); and generating the unified score using a predetermined model. For example, a cascade of models (e.g., GBMs) can be used to extract the plurality of initial features, generate the hierarchical features/embedding from the initial features, and determine a unified score from the hierarchical features.

In a fourth variant, the vehicle trip can be classified as a motorcycle trip based on one or more of the scores generated by the first, second, and/or third variants (e.g., with a tree-based model; with a classifier; etc.).

In a second set of variants, non-exclusive with the first set, the method can include: detecting a vehicle trip with a mobile user device; at the mobile user device, collecting a first dataset, the first dataset comprising movement data collected by at least one of: a motion sensor or a location sensor of the mobile user device; extracting features from the first dataset; based on the extracted features, determining a vehicle modality score; classifying a modality of the vehicle trip based on the vehicle modality score; and triggering an action based on the vehicle trip classification.

In a first variant, features can be extracted for various segments of data (e.g., temporal windows, such as 30 second windows) within the first data segment, and separately scored for each segment.

In a second variant, features can be extracted for time periods surrounding vehicle events (e.g., detected based on sensor data and/or event classifications). For example, features can be extracted and separately scored for individual lane change events, cornering events, braking events, acceleration events, and/or any other suitable events.

In a third variant, separate features (e.g., determined for separate motion characteristics and/or using separate sensors) can be extracted across a full duration of the trip to determine a unified score for the full duration of the trip (e.g., from a start of initial movement to trip completion and/or from a start of initial movement to a present time). The unified score can be determined by: extracting a set of hierarchical features from the separate features, each embedding data from a plurality of separate features (e.g., relating distinct separate features of the plurality); and generating the unified score using a predetermined model. For example, a cascade of models (e.g., GBMs) can be used to extract the plurality of initial features, generate the hierarchical features/embedding from the initial features, and determine a unified score from the hierarchical features.

In a fourth variant, the vehicle trip can be classified based on one or more of the scores generated by the first, second, and/or third variants.

### 2 Benefits

Variations of the technology can afford several benefits and/or advantages.

First, variations of this technology can leverage non-generic location data (e.g., location datasets, GPS data, etc.) and/or motion data (e.g., motion datasets, accelerometer data, gyroscope data, etc.) to conveniently and unobtrusively determine the vehicle motion characteristics during a trip and/or classify a vehicular transport modality (e.g., motorcycle, car, truck, etc.). In variants, vehicular transport modalities and/or motion characteristics can be classified during a trip (e.g., before the conclusion of the driving session; in near real time; periodically) which can be useful for initiation of safety algorithms, provision of business content (e.g., insurance content associated with a particular vehicle and/or vehicular transportation modality; service offerings associated with a particular vehicle type, etc.), and/or collision detection algorithms (e.g., where a phone may be damaged during an accident, etc.). In examples, the location data and/or motion data can be passively collected at a user’s mobile computing device (e.g., a smartphone, a tablet, etc.), such that the technology can perform trip event determinations and/or receive driving-related communications without requiring a user to purchase additional hardware (e.g., a specialized onboard device for monitoring traffic-related events, a purpose-built such device, etc.). In variants, the technology can be used to determine a vehicle transportation modality associated with a trip detected as described in U.S. Application Number 16/201,955, filed 27-NOV-2018, which is incorporated herein in its entirety by this reference.

Second, the technology can improve the technical fields of at least vehicle telematics, inter-vehicle networked communication, computational modeling of traffic-related events, and traffic-related event determination with mobile computing device data. The technology can continuously collect and utilize non-generic sensor data (e.g., location sensor data, motion sensor data, GPS data, audio/visual data, ambient light data, etc.) to provide real-time and/or near real-time determinations of traffic-related events and communication of those events to potentially affected entities. Further, the technology can take advantage of the non-generic sensor data and/or be used with supplemental data (e.g., vehicle sensor data, weather data, traffic data, environmental data, biometric sensor data, etc.) to better improve the understanding of correlations between such data and traffic-related events and/or responses to such events, leading to an increased understanding of variables affecting user behavior while driving and/or riding in a vehicle and/or traffic behavior at the scale of a population of users driving vehicles. In a first variant, the technology can be used to determine a transportation modality to be used in conjunction with the accident detection and/or response methods as described in U.S. Application Number 15/243,565, filed 22-AUG-2016, which is incorporated herein in its entirety by this reference. In a second variant, the technology can be used to classify of vehicular transportation modalities from sensor data which can be used to infer traffic laws when used in conjunction with U.S. Application Number 16/022,184, filed 28-JUN-2018, which is incorporated herein in its entirety by this reference.

Third, the technology can provide technical solutions necessarily rooted in computer technology (e.g., automatic data collection via a mobile computing platform, utilizing computational models to characterize vehicle transportation modalities and/or determining traffic-related events from non-generic sensor datasets collected at mobile computing devices, updating the computational models based on event determination and/or communication accuracy, etc.) to overcome issues specifically arising with computer technology (e.g., issues surrounding how to leverage movement data collected by a mobile computing device to determine traffic-related events, how to automatically communicate traffic-related information to initiate traffic-related actions for responding to traffic-related characterization, etc.).

Fourth, the technology can leverage specialized computing devices (e.g., computing devices with GPS location capabilities, computing devices with motion sensor functionality, wireless network infrastructure nodes capable of performing edge computation, etc.) to collect specialized datasets for characterizing traffic behaviors executed by the vehicle (e.g., under the influence of the driver’s control, when controlled by an autonomous control system, etc.).

However, variations of the technology can additionally or alternately provide any other suitable benefits and/or advantages.

### 3 System

The system 100, an example of which is shown in FIG. 1, can include a plurality of data processing modules, which can include: a feature generation module 120, a scoring module 130, an optional decision module 140, an optional trip detection module 115, and/or any other suitable data processing modules. The system can optionally include a mobile device 110 (e.g., such as a mobile cellular telephone, user device, etc.) and/or can be used in conjunction with a mobile device 110 (e.g., receive data from an application executing at the mobile device and/or utilize mobile device processing, etc.). However, the system 100 can additionally or alternatively include any other suitable set of components. The system functions to facilitate execution of method Block S200 and/or can function to classify a vehicular transportation modality (e.g., motorcycle transportation) for a vehicle trip.

The system can optionally include and/or be configured to interface with a mobile device 110 (e.g., user device), which functions to collect sensor data (such as in accordance with Block S210 of the method). Examples of the mobile device include a tablet, smartphone, mobile phone, laptop, watch, wearable devices, or any other suitable user device. The user device can include power storage (e.g., a battery), processing systems (e.g., CPU, GPU, memory, etc.), sensors, wireless communication systems (e.g., a WiFi transceiver(s), Bluetooth transceiver(s), cellular transceiver(s), etc.), or any other suitable components. The sensors of the user device can include vehicular movement sensors (e.g., measuring movement relative to Earth’s gravitational field; relative to a weight vector of the mobile device), which can include: location sensors (e.g., GPS, GNSS, etc.), inertial sensors (e.g., IMU, accelerometer, gyroscope, magnetometer, etc.), motion sensors, force sensors, orientation sensors, altimeters, and/or any other suitable movement sensors; user-facing sensors, which can include: cameras, user input mechanisms (e.g., buttons, touch sensors, etc.), and/or any other suitable user-facing sensors; and/or any other suitable sensors. However, the system can include and/or be used with any other suitable mobile device(s).

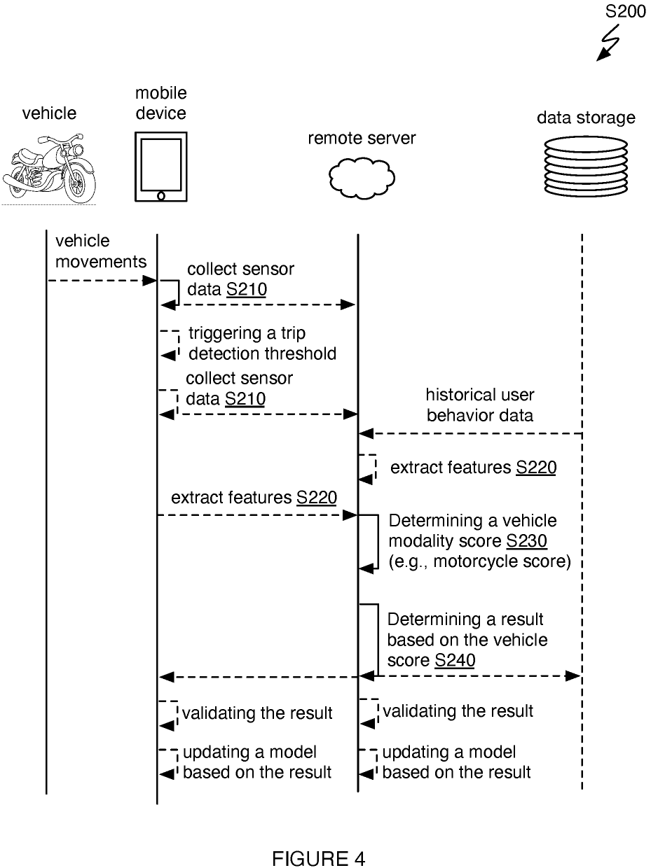

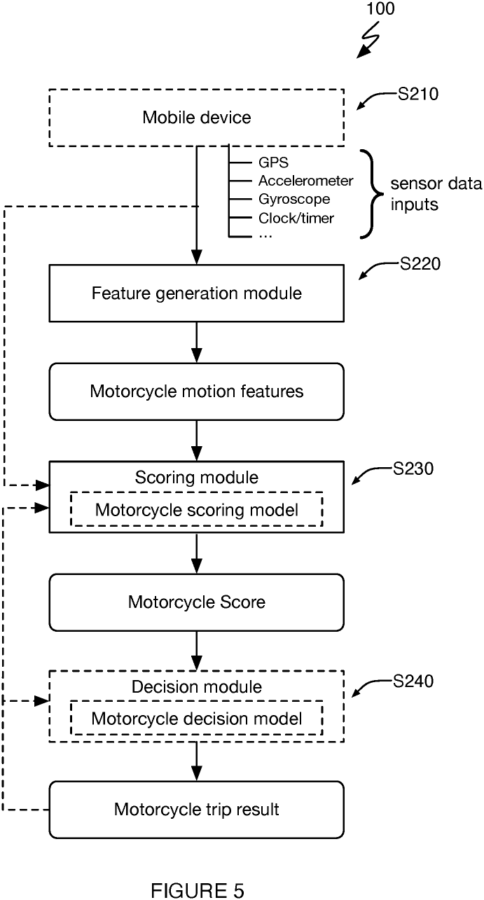

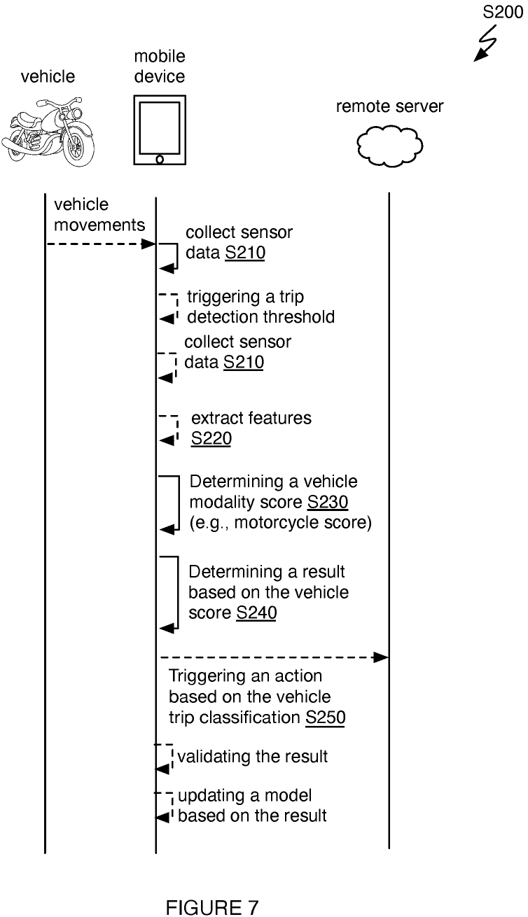

The data processing modules function to facilitate execution of S200 and/or sub-elements therein. Data processing modules can include local processing elements (e.g., executing at the user device and/or within an application of the mobile device), remote processing elements (e.g., executed at a remote server, cloud processing etc.), and/or any other suitable data processing. Data processing modules can be centralized and/or distributed (e.g., across multiple processing nodes), and can be executed at thesame endpoint or different endpoints. In variants, S200 can be entirely performed at the mobile device (e.g., an example is shown in FIG. 7). Alternatively, a portion of S200 elements can be executed at the mobile device and a remainder can be executed at a remote server based on a trigger or call from the mobile device (e.g., an example is shown in FIG. 4). However, processing of S200 can be otherwise suitably distributed between system endpoints and/or processing nodes.

In variants, the data processing modules can include a feature generation module 120, which functions to extract features from the data collected by the mobile device in accordance with Block S220 of the method. In an example, the feature generation module can extract features from the sensor data according to a predetermined set of rules, heuristics, or other techniques. However, the system can include any other suitable feature generation module(s), and/or can otherwise extract features from the data at any suitable endpoints.

In variants, the data processing modules can include a scoring module 130, which functions to determine a vehicle modality score - such as a motorcycle classification probability - based on the extracted features and/or sensor data. Additionally or alternatively, the scoring module can function to generate Block S230 of the method. The scoring module can generate the vehicle modality score using a scoring model which can include one or more: a gradient boosting machine (GBM), a regression model, a neural network model (e.g., DNN, CNN, RNN, etc.), a cascade of neural networks, compositional networks, Bayesian networks, Markov chains, predetermined rules, probability distributions, heuristics, probabilistic graphical models, and/or other models; and/or a combination thereof. However, the system can include any other suitable scoring model(s) and/or scoring modules.

In variants, the data processing modules can include a decision module 140 which functions to determine a result in accordance with Block S240 of the method. The decision module can determine the result using a decision model which can include: a tree-based model (e.g., decision tree; binary classifier), heuristic model, a regression model, a neural network model (e.g., DNN, CNN, RNN, etc.), a cascade of neural networks, compositional networks, Bayesian networks, Markov chains, probabilistic graphical models, and/or other models. However, the system can include any other suitable decision model(s) and/or decision module(s).

The data processing modules can optionally include a trip detection module 115, which functions to detect a trip based on a movement of the mobile device in accordance with Block S215 of the method. In a specific example, the trip detection module can operate as described in U.S. Application Number 16/201,955, filed 27-NOV-2018, which is incorporated herein in its entirety by this reference. However, the system can include or be used with any other suitable trip detection module and/or can otherwise exclude a trip detection module.

However, the system can include any other suitable components.

### 4 Method

The method, an example of which is shown in FIG. 2, can include: optionally generating a trained trip detection system S100; and performing inference using the trained trip detection system S200. The method functions to facilitate determination of vehicle motion characteristics and/or to classify a vehicular transportation modality (e.g., a motorcycle trip) for a vehicle trip. However, the method can additionally or alternatively include any other suitable elements.

In a specific example, S200 can output a binary classification result (a.k.a., trip verdict), classifying a trip as a motorcycle trip or a non-motorcycle trip.

Block S200, an example of which is shown in FIG. 3, can include: optionally collecting sensor data at a mobile device S210; optionally detecting a vehicle trip S215; determining features based on the sensor data S220; determining a vehicle modality score based on the features S230; determining a result based on the vehicle modality score S240; and optionally providing content and/or triggering an action (e.g., initiating an emergency response, updating a risk score associated with the driver, contacting the driver, providing insurance content, etc.) based on the result S250. S200 functions to classify a vehicular transportation modality (e.g., a motorcycle trip) for a vehicle trip. S200 can additionally or alternatively function to determine vehicle motion characteristics for a trip. However, method Block S200 can additionally or alternatively include any other suitable elements.

### 2.1 Data Collection

Collecting sensor data at a mobile device S210 functions to collect data to be used to determine a vehicle trip and/or classify a vehicular transportation modality. Sensor data is preferably collected at the mobile device and/or sensors therein (e.g., movement sensors, location sensors, user-facing sensors, etc.). Data collected during S210 can include: location data (e.g., latitude/longitude, GPS, GPS accuracy, etc.), acceleration data (e.g., 6 axes, linear, rotational, etc.), velocity (e.g., integrated from inertial acceleration data), orientation (e.g., relative to gravity), data from any other suitable mobile device sensors, vehicle connection data, and/or any other suitable data. Mobile device sensor data can be collected continuously, periodically, in response to a trip detection (e.g., in accordance with Block S215), synchronously, asynchronously (e.g., between various mobile device sensors), and/or with any other suitable timing. In variants, S210 can include storing data locally at the mobile device and/or transmitting mobile device sensor data to a remote endpoint, such as a remote processing and/or data storage system (e.g., remote server, cloud processing, etc.). Data can be collected/stored in a time domain (e.g., timestamped measurements, ordered/sequential measurements) and/or frequency domain (e.g., for vibration data, such as accelerations over a collection interval/period), or can be otherwise suitably indexed/stored. Alternatively, sensor data may not be stored after features are extracted and/or may only be stored locally at the user device (e.g., during a trip, prior to trip classification, etc.).

However, sensor data can be otherwise suitably collected.

Optionally detecting a vehicle trip S215 functions to serve as a trigger for sensor data collection with one or more sensors of the mobile device, feature generation, and/or classification of the trip. A vehicle trip can be determined based on the sensor data collected in S210 and/or a subset thereof. In one variant, a vehicle trip can be detected based on a movement of the mobile device by the method described in U.S. Application Number 16/201,955, filed 27-NOV-2018, which is incorporated herein in its entirety by this reference. In an example, a vehicle trip can be determined based on a subset of the mobile device sensors (e.g., with an accelerometer; in response to satisfaction of a geofence trigger; etc.) and trigger data collection using a second subset of sensors of the mobile device.

In variants, S215 can detect a trip while the trip is ongoing (e.g., which may facilitate trip classification contemporaneously with the trip), but can additionally or alternatively detect a full duration of a trip, after completion of the trip and/or based on completion of the trip (e.g., which may facilitate trip classification based on an entire duration of the trip).

Trip detection is preferably performed locally (e.g., onboard the mobile device), but can alternatively be performed remotely and/or at any other suitable endpoint(s). In a specific example, S215 can detect a trip based on coarse sensor data (e.g., low data collection frequency, based on a subset of sensors, with minimal power and/or processing bandwidth utilization, etc.) and can trigger collection of granular sensor data during a trip (e.g., which may continue for a duration of the trip, until a termination of the trip is detected, until a vehicle modality of the trip is classified, etc.).

In variants, detecting the vehicle trip can include: at an application of the mobile user device operating in an idle state, determining satisfaction of a geofence trigger; and in response to determining satisfaction of the geofence trigger, executing a set of hierarchical tests according to a tree-based model to detect a start of the vehicle trip. In an example, the set of hierarchical tests are based on data collected by at least one of: a motion sensor or a location sensor of the mobile user device.

However, a vehicle trip can be otherwise suitably determined. Alternatively, the method can be executed independently of and/or without detection of a vehicle trip.

### 2.2 Feature Determination/Extraction

Determining features based on the sensor data S220 functions to provide a statistical characterization of vehicle dynamics (and/or mobile device dynamics or operational characteristics within a moving vehicle) which can be used as a basis for comparison/evaluation of the collected data. Additionally or alternatively, features can be used to score/classify a vehicular transportation modality in accordance with Block S230 and/or Block S240 of the method. As a first illustrative example, vehicular transportation modalities generally exhibit different jerk characteristics—for instance a train or bus may frequently exhibit more gradual changes in acceleration when compared with a motorcycle. As a second illustrative example, vehicular transportation modalities may exhibit distinct roll characteristics—for instance cornering a motorcycle may result in a roll moment towards the center curvature (of the road and/or vehicle cornering path). As a third illustrative example, vehicular transportation modalities may generally exhibit different vibration characteristics associated with the size/RPM of the engine or style of suspension. As a fourth illustrative example, average trip characteristics such as acceleration (e.g., positive acceleration, deceleration/braking, rotational/cornering accelerations, etc.) and/or combined features (e.g., fused jerk and cornering, number of lane change identifications, etc.) may be distinguishable across a full duration of a trip (e.g., in addition to during specific events, such as during a cornering maneuver or a lane change maneuver; or a large trip interval spanning multiple such events). As a fifth illustrative example, features can be associated with various modality-specific vehicle characteristics and/or movement characteristics. In a sixth illustrative example, the set of features can include an interquartile range (IQR) of vehicular accelerations (e.g., which may be distinguishably different between a motorcycle and a bus/car). In a seventh example, the set of features can include frequency domain characteristics (e.g., max magnitude and/or parameter value within a particular frequency spectrum, etc.) and/or estimated vehicular parameters derived therefrom (e.g., engine frequency, estimated suspension characteristic etc.). Alternatively, frequency domain characteristics associated with vehicular parameters may be analyzed without any specific parameter estimates for the vehicle derived therefrom. However, any other suitable features can be determined.

Features can relate set(s) of sensor data which can include: time domain data, frequency domain data, localization data, motion data, user behavior data (e.g., device utilization, etc.), and/or any other suitable sensor data and/or mobile device data. Features can include: statistical features (e.g., central tendency metrics, aggregate parameters, statistical parameters, etc.), behavioral features (e.g., utilization patterns, etc.; associated with a user of the mobile device), movement features (e.g., of the mobile device; associated with movements relative to a weight vector of the mobile device and/or gravity-relative movements), location features, contextual features (e.g., based on stored historical or external datasets; an example is shown in FIG. 8), and/or any other suitable data features. Features can be extracted from a single sensor or a combination of multiple sensors (e.g., multiple sensor types, such as an accelerometer and a gyroscope). Features are preferably generated algorithmically according to a predetermined set of rules/heuristics (e.g., manually assigned, pre-generated by a computer, etc.), but can be otherwise suitably generated, such as using one or more pre-trained models (e.g., neural networks, fully convolutional network [FCN], convolutional neural network [CNN], recurrent neural network [RNN], artificial neural network [ANN], a cascade or sequence of models, etc.), polynomial regression, and/or with any other suitable techniques. Features can be constructed from time segments of sensor data spanning: a full duration of a vehicle trip (e.g., between initial movement and trip completion), a partial duration of a vehicle trip (e.g., between trip detection and/or initiation and an instantaneous time, fixed time window, dynamic time window, etc.), and/or any other suitable period(s)/duration(s). Features are preferably generated at a local processor of the mobile device but can additionally or alternatively be generated at a remote processor and/or at any other suitable processing endpoint. Features can be generated: periodically, aperiodically, in response to satisfaction of a trigger condition (e.g., time trigger, speed threshold, etc.), during a vehicle trip (e.g., during movement of the mobile device within a vehicle, between detection of a vehicle trip and satisfaction of a trip termination condition), after a vehicle trip (e.g., in response to satisfaction of a trip termination condition), and/or with any other suitable timing.

In variants, sensor data used to generate features can optionally be filtered using integrated hardware and/or software, such as to remove signal noise, inaccurate data (e.g., remove low accuracy GPS data, etc.), anomalous data (e.g., statistical outliers, associated with a static mobile device, associated with a user manipulating a mobile device, etc.), and/or other data. For example, sensor data can be filtered to eliminate periods of data associated with a pickup signal (e.g., in-hand operation; based on gyroscope data, for example). Additionally or alternatively, sensor data can be fused between sensors (e.g., with any suitable sensor fusion techniques; such as with a Kalman Filter) prior to feature generation. In some variants, Kalman filtering techniques can be used to fuse sensor data across various sources in order to derive secondary signals—such as estimated phone movement relative to the vehicle—which can be used as additional features. Additionally or alternatively, derived/fused signals (e.g., a phone pickup signal) can be used to mask/filter various portions of the trip (e.g., where features may only be computed when the phone is stationary [e.g., not in-hand, in a stable mount, not in-pocket, not sliding around in a backpack and/or bag, etc.]). However, features can be generated using unfiltered, pre-filtered data, pre-processed data, other mobile device data, and/or any other suitable data.

In variants, feature generation can include segmentation of a trip dataset (e.g., collected during S210) into discrete intervals (e.g., 30 second intervals), which can be overlapping, non-overlapping, span a full duration of the trip, span a partial duration of the trip, and/or have any other suitable relationship.

In variants, S220 can generate features for a portion of the trip (e.g., multiple trip segments, overlapping segments, etc.) and/or an entirety of the trip.

In some variants, S220 can optionally include determining hierarchical features (e.g., which fuse/combine various features). As a first example, features can be determined using a first model (e.g., which extracts movement features) and a second model (e.g., which fuses/combines features and/or establishes relationships between features). As a second example, features can be generated via a cascade of models and/or feature generation processes in S230. Additionally or alternatively, hierarchical feature determination can be integrated into a scoring process and/or model-based determination as a part of S230 (e.g., initial layer of a model in S230, for example).

In a first set of variants, S220 can include removing user influences from the sensor data, which may reduce ‘noise’ in the data/features associated with user interactions. In a first example, S220 can include classifying the phone as either mounted or in-hand, such as with a predetermined classifier (e.g., NN classifier, tree-based classifier, model-based classifier, etc.). In a second example, user influences can be removed by estimating phone movements relative to the vehicle with a Kalman filter, which can be used as a derived signal for subsequent feature generation. In a third example, user influences can be removed by estimating a device pickup signal (e.g., based on gyroscope data) and filtering/masking in-hand periods based on the phone pickup signal. Alternatively, user influences and/or phone interactions can be used as a separate/additional feature which can be used to facilitate scoring (e.g., in S230) and/or classification (e.g., in S240).

In a first variant, S220 can include generating features for a plurality of temporal windows. In a second variant, S220 can include generating features associated with driving events (e.g., cornering, lane change, hard braking, etc., which can be used to detect/score driving events in S230). In a third variant, S220 can include generating movement features associated with movement characteristics across an entirety of a trip. In a fourth variant, S220 can include determining hierarchical features combining a plurality of features across a period of the trip (e.g., an entirety of a trip up to completion and/or a current time). As an example, a first predetermined model (e.g., GBM) can be used to generate a first set of features (e.g., movement features) for the sensor inputs, and a second predetermined model (e.g., second GBM) can be used to determine a set of hierarchical features (e.g., combining/fusing the first set of features to determine secondary statistical characterizations), each hierarchical feature based on a combination of features of the first set. In a fifth variant, S220 can include generating features corresponding to user influences and/or user interactions with the mobile device. In a sixth variant, S220 can include any combination/permutation of the first through fifth variants, where the features can be generated using the same model and/or different models.

However, features can be otherwise suitably determined.

### 2.3 Trip Classification

Determining a vehicle modality score based on the features S230 functions to evaluate the features and/or sensor data relative to historic features/data corresponding to a particular vehicle modality. The vehicle modality score is preferably determined using a trained scoring model, such as a GBM, which is trained to generate a score for a particular vehicle class (e.g., motorcycle) based on a statistical evaluation of the set of extracted features (e.g., relative to a training dataset, weighted, etc.). The vehicle modality score is preferably a binary classification probability (e.g., whether the features/dataset are associated with the dynamics of a specific vehicle class for which the model is trained), but can alternatively be a multiclass classification probability, and/or any other suitable scoring parameter. As an example, a motorcycle scoring model (e.g., a GBM) can be trained (e.g., based on a first training set which includes a mix of route segments from motorcycle trips and non-motorcycle trips) to assign a motorcycle classification probability to a set of features extracted from a trip segment in S220. Vehicle modality scores can be determined for individual features, a combination of features, and/or the complete set of features generated in S220 over any suitable time interval(s). A vehicle modality score(s) can be determined once (e.g., for an entirety of the trip or an elapsed portion of the trip preceding a present time, etc.), periodically (e.g., for a features corresponding to a particular time segment of the mobile device data, such as every 30 seconds), for individual segments of feature data or for a series of segments (e.g., all segments between trip detection and an instantaneous time, a window of the last N segments), at discrete time intervals, and/or with any other suitable timing. In a specific example, a vehicle score can be determined for each of a set of discrete intervals or trip segments (e.g., 30 second intervals; such that multiple vehicle scores are produced for a trip, such that the vehicle score is iteratively refined as the trip progresses, etc.). The scores for these multiple segments can optionally be aggregated (e.g., added, averaged, combined in a weighted fashion, etc.) to determine an overall score (e.g., probability) associated with the trip. Alternatively, the scores can be processed individually, the scoring operation can be unitary, and/or the score(s) can be otherwise suitably determined or processed.

S230 preferably generates a vehicle modality score for a portion of the trip (e.g., for a set of features corresponding to a portion of the trip), but can additionally or alternatively generate a vehicle modality score for an entirety of the trip and/or multiple (overlapping, non-overlapping) segments of a trip. In a first set of variants, scores can be determined separately for a plurality of discrete temporal windows or segments of the trip (e.g., segmented based on time, movement distance, geographic region, event detection, etc.). In a second set of variants, scores can be determined separately for a plurality trip events (e.g., lane change events, cornering events, acceleration events, hard braking events, start and stop events, etc.; detected based on the extracted trip features and/or sensor data, etc.). In a third set of variants, a score can be determined for an entirety of the trip (and/or an elapsed portion of the trip preceding a present time, which may span multiple/all trip events). As an example, scoring in S230 which can aggregate data across a full trip under a single score may facilitate classification based on additional behavioral or stylistic differences between various transportation modalities (e.g., overall ‘smoothness’ of a ride, how a gravity vector changes throughout a trip, etc.) in addition to characterizations associated with specific event windows (e.g., cornering dynamics or lane change motion, for example).

The score(s) can be directly determined from the features extracted in S220, and/or determining the score(s) can be include determining one or more intermediate outputs which embed or fuse multiple features into one or more sets of intermediate/secondary outputs (a.k.a., “hierarchical features”). For example, a single model (e.g., such as a GBM) can directly transform a set of features (e.g., for an entirety of the trip; for a portion/window of the trip) into a score. Alternatively, a first model can transform the set of features into a second set of embedded/secondary features as an intermediate output, which can be used by a second model (e.g., such as a second GBM) to generate a score.

Accordingly, scores can be generated by using a set of scoring models which can include one or more: gradient boosting machines (GBM), regression models, a neural network models (e.g., DNN, CNN, RNN, etc.), a cascade of models (e.g., cascade of neural networks; cascade of GBMs; etc.), a compositional model (e.g., compositional networks), Bayesian networks, Markov chains, predetermined rules, probability distributions, heuristics, probabilistic graphical models, and/or other models; and/or any suitable combination, permutation, or sequence thereof. For example, a score can be generated for an entirety of a trip with a hierarchical sequence of GBMs.

In variants, the set of scoring models can be global/generalized models (e.g., commonly used for all users/regions), regional models (e.g., predetermined/pre-trained for a specific region based on region-specific data, regional vehicles, roadway characteristics, regional maps, etc.), user-specific models (e.g., predetermined/pre-trained for a particular user of the mobile device based on historical user data), and/or any other suitable combination/permutation thereof. In an illustrative example, driving behavior patterns in areas with wide/bumpy dirt roads may be distinct from urban centers with high traffic congestion. As a second illustrative example, vehicle vibration characteristics may be region specific (e.g., based on the types/classes of motorcycles available or most commonly utilized). As a third example, characteristic differences between driving patterns of motorcycles and other roadway vehicles may be globally distinct/distinguishable.

However, the vehicle modality score can be otherwise suitably determined.

Determining a result based on the vehicle modality score S240 functions to determine a transportation modality of a vehicle trip using the vehicle modality score. The result can be a binary classification (e.g., motorcycle trip, non-motorcycle trip), a multi-class classification (e.g., car, train, motorcycle, etc.), and/or other transportation modality result. The result can optionally include a classification probability (e.g., 75% probability that the mode of transportation is a motorcycle), or otherwise exclude a probability. The result can be determined: once (e.g., for a particular trip); during and/or after a trip; repeatedly, such as where the result can be recomputed/refined (e.g., until the classification satisfies a probability/confidence threshold, such as a 98% classification probability) based on additional trip segments; and/or with any other suitable frequency/timing.

The result is preferably generated using a trained decision model, such as a tree-based model or neural network classifier, which can receive one or more vehicle modality scores as an input (and optionally any other inputs). In a first variant, the decision model can receive as an input the vehicle modality score for each segment of a trip (e.g., corresponding to the set of features). Alternatively, the score and/or output of a scoring module can be directly taken as a classification result (e.g., where the classification probability/confidence exceeds a predetermined threshold; when implemented with a system variant which excludes a decision module).

Block S200 can generate a classification results for the vehicle transportation modality of a trip: during the trip (e.g., based on partial data for the trip and/or for one or more segments of a trip prior to an instantaneous time; in real-time or near-real time), after the trip (e.g., based on complete data for a trip, etc.), once, repeatedly, periodically, in response to satisfaction of a classification event (e.g., trip detection according to S215, a temporal trigger, a request by a remote server, motion trigger event, manual classification request, etc.), and/or with any other suitable timing/frequency. In a specific example, Block S200 can include generating a real-time classification result for a trip and/or a segment thereof. However, Block S200 can occur with any other suitable timing/periodicity.

In an illustrative example, S240 can be performed repeatedly at various times during a trip, which can refine/improve the confidence of the result (e.g., classification probability). Results may be generated until the confidence (e.g., classification probability) exceeds a predetermined threshold (e.g., action trigger for S250) or throughout the entirety of a trip.

In a first variant, S240 can determine a result based on a collation of modality scores of S230 (e.g., for various portions of a trip).

In a second variant, S240 can determine a result directly based on features obtained from the entirety of a trip in S220.

In a third variant, S240 can determine a result based on a single score, corresponding to classification of a full duration of a trip (or an elapsed duration of a trip, such as a portion of the trip preceding the present time).

However, a result can be otherwise suitably determined.

### 2.4 User Content and/or Actions

Optionally providing content and/or triggering an action based on the result S250 can function to provide user content and/or mobile device services based on the transportation mode (and/or activity of the user). In variants, content can include: collision assistance, traffic/navigational assistance, insurance assistance (e.g., usage based insurance), vehicle-related advertising (e.g., maintenance services, etc.), and/or any other suitable content. Content can be provided via the mobile device (e.g., via a device API) or external systems (e.g., emergency service alerting, insurance platform, etc.). However, any other suitable content can be otherwise provided based on the result, or else may be altogether not provided to the user. Additionally, any other suitable actions can be automatically triggered based on the result (e.g., satisfaction of a threshold confidence and/or classification probability), such as, but not limited to: triggering an ambulance to travel to the location of a suspected collision, updating a risk score associated with a driver of the vehicle based on driving behavior detected during the trip, and/or any other actions.

In variants, S250 can include updating a usage-based insurance policy based on the result. For example, S250 can include (automatically) updating a usage parameter of a usage-based insurance policy, such as a usage-based motorcycle insurance policy, for the user based on the result. The usage-based insurance policy can be updated based on the distance (e.g., mileage) and/or duration of the trip, upon completion of the trip (e.g., after completion of the trip and/or classification of the trip) and/or in response to a user confirmation of the trip classification (and/or distance). In a second example, S250 can include: based on the classification result, selectively updating a parameter of one insurance policy (e.g., a usage parameter of a usage-based motorcycle insurance policy) of a plurality of insurance policies associated with the user (e.g., where the user holds a motorcycle insurance policy and an automobile insurance policy, for example).

In variants, S250 can additionally or alternatively include recommending an insurance policy for the user based on a determination that the user is riding and/or operating a motorcycle (e.g., such that a motorcycle-specific insurance policy can be recommended) and optionally based on any other information (e.g., a risk score determined for the user, a quality of driving score determined for the user, etc.). In some examples, for instance, a motorcycle-specific policy and/or an insurance policy with motorcycle coverage can be recommended to the user. In additional or alternative examples, the determined information can be used to determine (e.g., calculate, reference in a lookup table, etc.) a quote (e.g., price) for potential insurance policies (e.g., for different insurers), such that these quotes can be provided to the user (e.g., at an application executing on a user device) and he or she can optionally choose to select an insurer based on these quotes (e.g., comparison to find lowest cost and/or otherwise best quote/coverage).

In some variants, trip classification during a trip can facilitate timely actions and/or improvements to content provision during the trip, such as: improved navigational assistance, transportation-modality-based advertising during a trip, and/or any other suitable advantages. Additionally, pre-classification of trips prior to an accident occurring may facilitate an improved or more timely accident response.

However, any other suitable content provisions and/or actions can be facilitated based on the transportation mode classification.

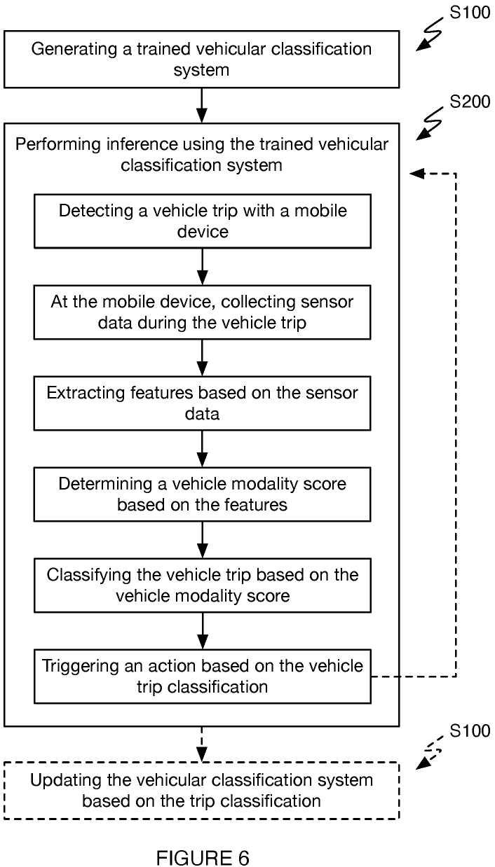

Optionally generating a trained vehicular classification system S100 functions to generate a trained scoring model and/or a trained decision model which can be used to classify modes of vehicular transportation (e.g., according to S200). In one variant, S100 can include training a scoring model(s) using a first training dataset and the decision model(s) using a second training dataset (e.g., which differs from the first training dataset). The first training dataset includes features extracted from a mix of trip data (e.g., labeled in association with a vehicle class). The second training dataset includes a separate mix of trip data segments (separate and distinct from those used to train the scoring module), which are then passed through the trained scoring model and used to train the decision model. Preferably, the scoring model and/or decision model are be unchanged during execution of the method (e.g., having a prior trained scoring model and/or decision model), but can additionally or alternatively be modified or updated based on the result (e.g., after the trip, at a subsequent training time, etc.; after subsequent validation by a human, such as by a user confirmation; in a supervised, semi-supervised, or unsupervised manner; etc.; an example is shown in FIG. 6). However, the vehicular classification system can be otherwise suitably trained.

In variants, results can optionally be validated by a user (e.g., via the mobile user device), which can be used to adjust content (e.g., validate automatic updated to a usage parameter of a usage-based insurance policy), update scoring and/or decision models, and/or otherwise used.

Alternative embodiments implement the above methods and/or processing modules in non-transitory computer-readable media, storing computer-readable instructions. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the preferred embodiments of the invention without departing from the scope of this invention defined in the following claims.

We claim:

1. A method comprising:
at a mobile user device, automatically detecting a vehicle trip associated with vehicular transportation of the mobile user device using at least one of: a motion sensor of the mobile user device or a location sensor of the mobile user device;
collecting a first dataset comprising movement data associated with at least one of: the motion sensor or the location sensor of the mobile user device;
extracting features from the first dataset, the features comprising a movement feature associated with at least one of: a vehicle roll characteristic, a vehicle acceleration characteristic, or a vehicle vibration characteristic;
at the mobile user device, determining a motorcycle score based on the extracted features using a predetermined scoring model;
based on the motorcycle score exceeding a confidence threshold, classifying the vehicle trip as a motorcycle trip with a tree-based decision model; and
triggering an action based on the vehicle trip classification.

2. The method of claim 1, wherein the action comprises: based on the first dataset, updating a usage parameter of a usage-based motorcycle insurance policy associated with a user of the mobile user device.

3. The method of claim 1, wherein extracting features further comprises: extracting a set of hierarchical features from the movement features, wherein each hierarchical feature corresponds to a period spanning the vehicle trip.

4. The method of claim 1, wherein the scoring model comprises at least one gradient boosting machine (GBM).

5. The method of claim 1, wherein the action comprises: updating at least one of a motorcycle scoring model or a motorcycle classification model based on the vehicle trip classification and the extracted features.

6. The method of claim 1, wherein the vehicle trip is classified as a motorcycle trip during the vehicle trip.

7. The method of claim 1, wherein the movement feature is associated with a full duration of the vehicle trip.

8. The method of claim 1, wherein the movement feature is determined relative to a weight vector of the mobile device.

9. A method comprising:
detecting a vehicle trip with a mobile user device;
at the mobile user device, collecting a first dataset, the first dataset comprising movement data collected by at least one of: a motion sensor or a location sensor of the mobile user device;
extracting features from the first dataset comprising:
extracting a first set of features using a first predetermined model based on the first dataset; and
extracting a set of hierarchical features from the first set of features, wherein each hierarchical feature corresponds to a period spanning the vehicle trip;
based on the extracted features, determining a vehicle modality score;
classifying a modality of the vehicle trip based on the vehicle modality score; and
triggering an action based on the vehicle trip classification.

10. The method of claim 9, wherein the vehicle modality score comprises a motorcycle score; wherein the modality comprises motorcycle transportation.

11. The method of claim 10, wherein the features comprise a first feature associated with a vehicle roll characteristic.

12. The method of claim 10, wherein the features comprise a first feature associated with a vehicle vibration characteristic.

13. The method of claim 10, wherein the features comprise a first feature associated with a high-order-derivative of a vehicle pose parameter.

14. The method of claim 9, wherein the action comprises: based on the first dataset, updating a usage parameter of a usage-based insurance policy associated with the modality of the vehicle trip.

15. The method of claim 9, wherein the vehicle modality score is determined with a third predetermined model, wherein the third predetermined model is tree-based.

16. The method of claim 9, further comprising: prior to extracting features, segmenting the first dataset based on at least one of: temporal events or event triggers, wherein the first set of features are extracted separately for each of a plurality of segments of the first dataset, wherein a respective vehicle modality score is determined for each segment of the plurality based on the extracted features, wherein the vehicle modality classification is based on the respective vehicle modality scores for each segment of the plurality.

17. The method of claims 9, wherein the first predetermined model comprises a first gradient boosting machine (GBM), wherein the set of hierarchical features are extracted from the first set of features with a second GBM.

18. The method of claim 9, wherein detecting the vehicle trip comprises: at an application of the mobile user device operating in an idle state, executing a set of hierarchical tests according to a tree-based model to detect a start of the vehicle trip.

19. The method of claim 18, wherein the set of hierarchical tests are based on data collected by at least one of: the motion sensor or the location sensor of the mobile user device.

20. The method of claim 9, wherein the extracted features comprise parameters characterizing a full duration of the vehicle trip.
